(19) United States
(12) Patent Application Publication
(10) Pub. No.: US 2013/0289850 A1
(43) Pub. Date: Oct. 31, 2013

(54) Powertrain Systems For Vehicles Having Forced Induction Intake Systems

(71) Applicant: Coming Incorporated, Coming, NY (US)

(72) Inventors: Paul Oakley Johnson, Corning, NY (US); Randall D. Partridge, Califon, NJ (US)

(73) Assignee: Coming Incorporated, Coming, NY (US)

(21) Appl. No.: 13/686,248

(22) Filed: Nov. 27, 2012

Related U.S. Application Data
(60) Provisional application No. 61/640,048, filed on Apr. 30, 2012.

(51) Int. Cl. F02D 41/30

(52) U.S. Cl. CPC F02D 41/3005
USPC 701/104

(57) ABSTRACT

A powertrain system for a vehicle includes an engine having a plurality of engine cylinders each having an inlet port and an exhaust port, an intake manifold in fluid communication with the inlet ports of each of the engine cylinders of the engine, and a forced induction system coupled to the engine increasing an intake pressure of air in the intake manifold above ambient pressure. The powertrain system also includes a fuel delivery system supplying fuel to each of the engine cylinders of the engine. The fuel delivery system includes at least one fuel injector per engine cylinder, a fuel tank storing fuel having an intermediate-RON, and an on-board separator separating the fuel into a high-RON component and a low-RON component. The high-RON component and the low-RON component are delivered to each of the engine cylinders of the engine based on an engine operating parameter.

### CROSS-REFERENCE TO RELATED APPLICATIONS

This application claims the benefit of U.S. Provisional Application Ser. No. 61/640048, entitled “Powertrain systems for vehicles having forced induction intake systems,” filed Apr. 30, 2012.

### BACKGROUND

1. Field

The present specification generally relates to fuel delivery systems for vehicles having forced induction intake systems and, more specifically, to fuel delivery systems that separate fuel into high octane rating and low octane rating components.

2. Technical Background

Internal combustion engines deliver mechanical energy from combusting a chemical fuel source. In general, internal combustion engines process a working fluid according to a thermodynamic cycle that compresses the working fluid, ignites the fuel source in the working fluid to increase the pressure of the working fluid, and expands the working fluid to extract mechanical energy from the increase in pressure. An increase in the compression ratio of the working fluid corresponds to an increase in thermal efficiency of the internal combustion engine. However, for spark-ignition engines, an increase in compression ratio may increase the propensity for fuel source in the working fluid to undergo pre-ignition, which may be observed as “engine knock.” In general, engine knock is undesirable in spark-ignition engines. The effective compression ratio of engines having forced induction intake systems may be higher than the effective compression ratio of engines that are naturally aspirated.

To delay pre-ignition of the fuel source, fuel having a higher octane rating may be introduced to the working fluid. Such fuel reduces the likelihood of engine knock, and may allow increased power extraction of the engine by advancing timing to the maximum brake torque timing. Fuel having a higher octane rating typically requires additional processing and/or additives, which increases the retail cost of the fuel for a consumer. Further, engine knock is generally only observed at portions of the operating envelope of the engine. As such, fuel having higher octane rating is needed intermittently based on engine power demand.

Accordingly, alternative fuel delivery systems that provide high octane rating and low octane rating fuel to a forced-induction spark-ignition internal combustion engine from a fuel having an intermediate octane rating fuel supply are needed.

### SUMMARY

According to various embodiments, a powertrain system for a vehicle includes an engine having a plurality of engine cylinders each having an inlet port and an exhaust port, an intake manifold in fluid communication with the inlet ports of each of the engine cylinders of the engine, and a forced induction system coupled to the engine increasing an intake pressure of air in the intake manifold above ambient pressure. The powertrain system also includes a fuel delivery system supplying fuel to each of the engine cylinders of the engine. The fuel delivery system includes at least one fuel injector per cylinder, a fuel tank storing fuel having an intermediate-RON, and an on-board separator separating the fuel into a high-RON component and a low-RON component. The high-RON component and the low-RON component are delivered to each of the engine cylinders of the engine based on an engine operating parameter.

According to further embodiments, a powertrain system has an engine with a plurality of cylinders, an intake manifold in fluid communication with the engine cylinders, a forced induction system coupled to the intake manifold to increase pressure in the intake manifold above ambient, and a fuel delivery system supplying fuel to each of the engine cylinders. The fuel delivery system includes at least one fuel injector per engine cylinder, a fuel tank storing fuel at an intermediate-RON, and an on-board separator. A method of operating the powertrain system includes introducing the fuel to the on-board separator, pre-heating the fuel, and passing the fuel through a pervaporation membrane to separate the fuel into a low-RON component and a high-RON component. The method also includes cooling the low-RON component and the high-RON component and storing the high-RON component in a high-RON reservoir. The method further includes delivering air and fuel to the each of the engine cylinders, determining if compression or auto-ignition is occurring in any of the engine cylinders, and if knocking is detected, increasing a proportion of fuel delivered to each of the engine cylinders from the high-RON reservoir.

Additional features and advantages of the embodiments described herein will be set forth in the detailed description which follows, and in part will be readily apparent to those skilled in the art from that description or recognized by practicing the embodiments described herein, including the detailed description that follows, the claims, as well as the appended drawings.

It should be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts a powertrain system having an on-board separator and a forced induction system according to one or more embodiments shown or described herein;

FIG. 2 schematically depicts a hypothetical inter-cylinder pressure plot for an engine during the compression and expansion strokes according to one or more embodiments shown or described herein;

FIG. 3 schematically depicts a hypothetical indicated mean effective pressure plot for an engine over various spark timing settings according to one or more embodiments shown or described herein;

FIG. 4 schematically depicts a hypothetical indicated mean effective pressure plot for an engine over various spark timing settings according to one or more embodiments shown or described herein;

FIG. 5 schematically depicts a fuel delivery system according to one or more embodiments shown or described herein;

FIG. 6 schematically depicts a fuel delivery system according to one or more embodiments shown or described herein;

FIG. 7 schematically depicts a pervaporation member of an on-board fuel separator according to one or more embodiments shown or described herein;

FIG. 8 schematically depicts a pervaporation member of an on-board fuel separator having a partitioned monolith according to one or more embodiments shown or described herein;

FIG. 9 schematically depicts an engine control unit according to one or more embodiments shown or described herein;

FIG. 10 schematically depicts an engine cylinder according to one or more embodiments shown or described herein;

FIG. 11 schematically depicts an engine cylinder according to one or more embodiments shown or described herein;

FIG. 12 schematically depicts an engine cylinder according to one or embodiments shown or described herein;

FIG. 13A schematically depicts a perspective view of a segmented end cap according to one or more embodiments shown and described herein;

FIG. 13B schematically depicts a perspective view of a segmented end cap according to one or more embodiments shown and described herein; and

FIG. 13C schematically depicts a perspective view of a segmented end cap according to one or more embodiments shown and described herein.

### DETAILED DESCRIPTION

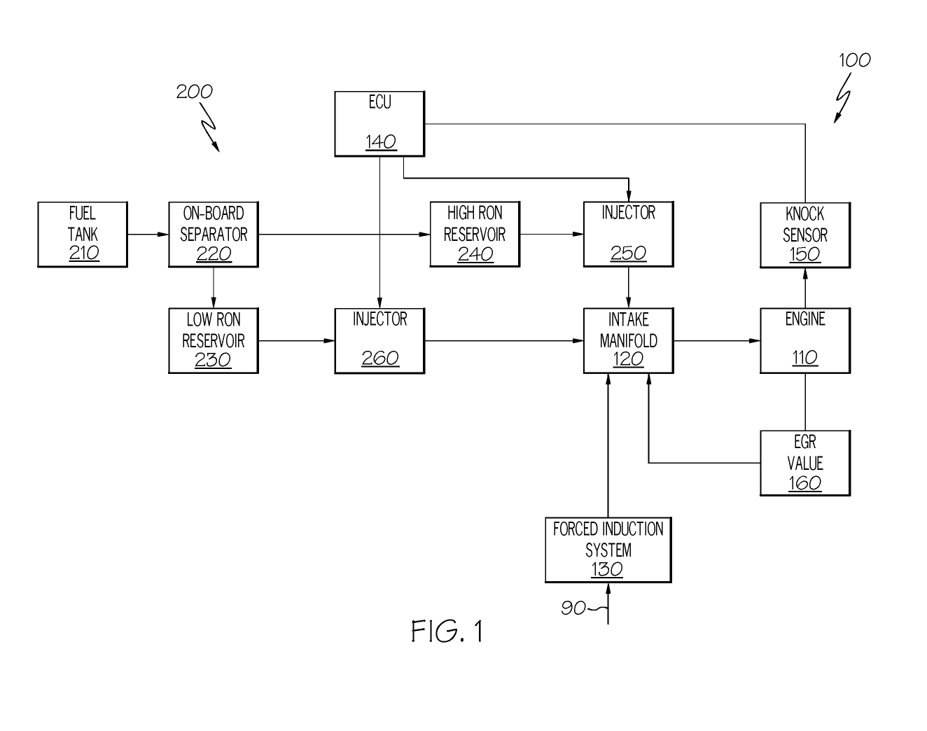

Reference will now be made in detail to embodiments of internal combustion engines having fuel delivery systems that separate a fuel supply into a low octane rating component and a high octane rating component and methods for operating the same. Whenever possible, the same reference numerals will be used throughout the drawings to refer to the same or like parts. One example of a powertrain system having such a fuel delivery system is schematically depicted in FIG. 1. A forced induction system is in fluid communication with an intake manifold and increases the pressure of air in the intake manifold. Fuel is delivered to one or more engine cylinders. The fuel delivery system includes a fuel tank for holding fuel, for example, fuel that is purchased by an end-user from a filling station. The fuel tank is in fluid communication with an on-board separator that separates a fuel stream into a low octane rating component and a high octane rating component. Each of the components of the fuel stream is stored separately from one another. An engine control unit evaluates performance parameters of the engine, including measuring engine knock in the engine cylinders. The engine control unit commands delivery of the low octane rating component and/or the high octane rating component based on the performance parameters of the engine and a signal provided by a knock sensor in the engine. The powertrain system and methods of operating the powertrain system will be described in more detail herein with specific reference to the appended drawings.

As used herein, the phrase “octane rating” refers to the propensity of the fuel to detonate. The phrase is used interchangeably with “Research Octane Number” (RON), which compares the resistance of the fuel to detonate to iso-octane and n-heptane.

As used herein, “brake” refers to measurement of engine performance evaluated at the crankshaft of the engine, before accessory and drivetrain losses are accounted for. As used herein, “indicated” refers to the theoretical power of an engine in converting the expanding working fluid to work if the engine were frictionless. Thus, brake engine performance parameters are equivalent to indicated engine performance parameters plus friction losses between the cylinders and the cylinder walls, windage losses, lubricant pumping losses, and the like. In general, an increase in an indicated engine performance parameter corresponds with an increase in a brake engine performance parameter.

As used herein, the phrase “reservoir” refers to a volume for storing fluid. In embodiments described herein, “reservoir” may be used interchangably to mean a tank, an accumulator, and/or a fuel line that holds fuel for delivery to a fuel injector.

Referring now to FIG. 1, a powertrain system 100 is schematically depicted. The engine 110 generally includes a plurality of engine cylinders that each include a piston that reciprocates in the engine cylinder to rotate a crankshaft, as is conventionally known. Each of the engine cylinders includes a cylinder head having intake valves in fluid communication with an intake manifold 120 and exhaust valves in fluid communication with an exhaust manifold. A forced induction system 130 is in fluid communication with an intake manifold 120, and increases the pressure of air 90 in the intake manifold 120.

Fuel is delivered to the engine cylinders in one or more of a variety of configurations. In the embodiment depicted in FIG. 1, fuel is delivered to the intake manifold 120, where the fuel is mixed with the air in the intake manifold 120 before the air enters the engine cylinders. The fuel delivery system 200 includes a fuel tank 210 for holding pump fuel. The fuel tank 210 is in fluid communication with an on-board separator 220 that separates a fuel stream into a low-RON component and a high-RON component. The high-RON component is returned to a high-RON reservoir 240. In some embodiments, the low-RON component is held in a low-RON reservoir 230. In other embodiments, the low-RON component is returned to the fuel tank 210. The high-RON component of the fuel stream is stored separately from the fuel stream having a lower RON, such that the portion of high-RON fuel delivered to the engine can be modified on demand.

The powertrain system 100 further includes an ECU 140. The engine control unit (ECU) 140 is electrically coupled to a plurality of engine components, including a throttle position sensor, an intake manifold pressure sensor, an air flow meter, an engine speed sensor, a crankshaft position sensor, fuel injectors, spark coils, an exhaust O₂ sensor, and the like. The ECU 140 evaluates performance parameters of the engine, including measuring engine knock in the engine cylinders. The ECU 140 commands delivery of the low octane rating component and/or the high octane rating component based on the performance parameters of the engine 110 and a signal provided by an engine knock sensor 150 in the engine.

Without being bound by theory, it is believed that increasing the compression ratio of the engine generally increases the thermal efficiency of the engine. The thermal efficiency of an engine operating according to the Otto cycle is approximated by:

$${η}_{th} = 1 - \frac{1}{{γ}^{r - 1}}$$

where γ is the ratio of specific heats of the working fluid (i.e., C_{P}/C_{V}) and r is the compression ratio of the engine. As the compression ratio of the engine increases, the thermal efficiency of the engine increases. The thermal efficiency of the engine reaches a practical limit, however, as the fuel detonates in compression ignition.

Forced induction systems 130 include turbochargers and superchargers. Turbochargers include compressors and turbines coupled to one another. The turbine of the turbocharger is positioned in fluid communication with the exhaust valves of the engine cylinders such that exhaust gas from the engine cylinders cause the turbine and the compressor to rotate. The compressor is positioned in fluid communication with the intake manifold, such that rotation of the compressor causes an increase in the pressure of the air in the intake manifold. Superchargers include compressors that are positioned in fluid communication with the intake manifold. The compressor of a supercharger is mechanically coupled to the crankshaft of the engine. Rotation of the crankshaft causes rotation of the compressor, which increases the pressure of air in the intake manifold. Both turbochargers and superchargers increase the pressure of the air in the manifold, such that a greater volume of air at standard temperature and pressure enters the engine cylinder than the maximum volume of the engine cylinder itself. As such, engines including forced induction systems typically exhibit volumetric efficiencies greater than unity. In addition, the effective compression ratio of an engine having a forced induction system is greater than the geometric compression ratio of the same engine. As such, engines including forced induction systems typically exhibit greater thermal efficiencies than naturally aspirated engines of the same piston, crankshaft, and engine cylinder configuration. Further, engines including forced induction systems may have reduced throttling losses caused by fluid flow across constricted volumes such as across throttle bodies and into and out of the engine cylinders across the engine valves.

For powertrain systems 100 including turbochargers, the turbocharger may include a wastegate (not shown) in fluid communication with the turbine. The wastegate is a valve that selectively diverts exhaust gases away from the turbine. The wastegate moderates exhaust gases to control turbine speed, which regulates maximum pressure in the intake manifold. In some embodiments, the wastegate may be passively controlled based on hydraulic pressure balance. In other embodiments, the wastegate may be actively controlled, for example using an electrically controlled wastegate.

For powertrain systems 100 including turbochargers, the turbocharger may include a variable-geometry turbocharger (not shown). In general, the upstream nozzles of a variable-geometry turbocharger vary in angle, opening or closing to modify the pressure and velocity of the exhaust gases directed over the turbine of the turbocharger. Variable-geometry turbochargers moderate exhaust gases introduced to the turbine to control turbine speed, which regulates maximum pressure in the intake manifold and regulates transient speed changes of the turbine and compressor.

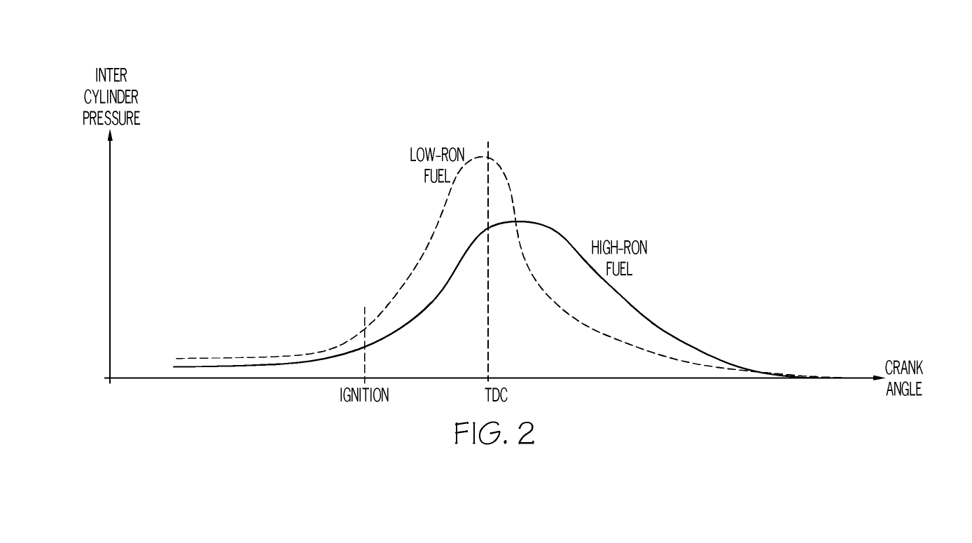

Referring now to FIG. 2, a hypothetical plot of pressure as measured inside an engine cylinder during a compression and expansion cycle is depicted. The pressure plot labeled “High-RON Fuel” depicts pressure in the engine cylinder in which the fuel is combusted by a spark ignition. The fuel is ignited at a point in the compression cycle before the piston reaches top dead center (TDC). The number of degrees of crank angle that the ignition is triggered before TDC is referred to as “spark advance.” In FIG. 2, the net integrated pressure in the engine cylinder evaluated over a complete engine cycle is referred to as indicated mean effective pressure (IMEP), which is a measurement of indicated engine power.

Still referring to FIG. 2, the pressure plot labeled “Low-RON Fuel” depicts pressure in the same engine cylinder, but where the fuel is detonated prior to spark ignition by compression ignition. As depicted, the pressure inside the engine cylinder increases more rapidly for the low-RON fuel than the pressure inside the engine cylinder for the high-RON fuel. This rapid increase in pressure is typically exhibited as “engine knock,” and can be sensed with the engine knock sensor. As depicted, compression ignition of the low-RON fuel leads to a large spike in the pressure in the engine cylinder before TDC, which results in a reduced IMEP as compared to the engine operating with the high-RON fuel.

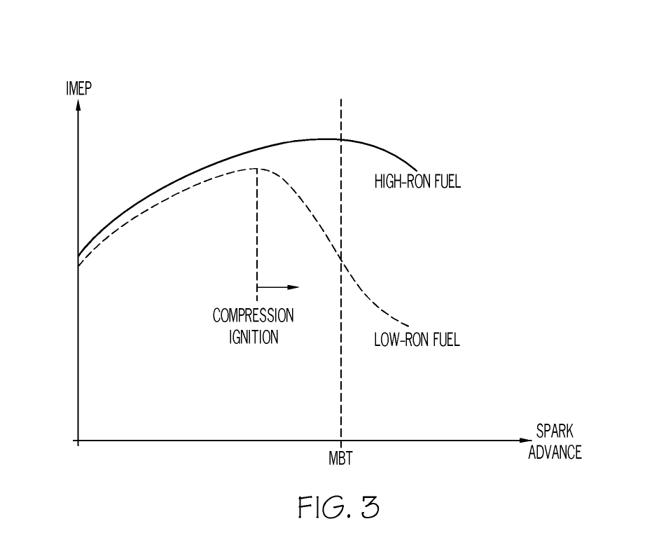

Referring now to FIG. 3, a hypothetical plot of the IMEP of an engine at full power demonstrates that IMEP will vary based on spark advance of the spark ignition source. For example, for the IMEP plot labeled “High-RON Fuel,” IMEP of the engine increases with increasing spark advance until reaching maximum brake torque (MBT) timing. After MBT timing, IMEP of the engine begins to decrease. The MBT timing represents the maximum net integrated pressure for the engine cylinder at a given operating point. It should be understood that the MBT timing will vary for a given engine operating condition such as, for example, engine load, engine speed, and ambient temperature and pressure.

Still referring to FIG. 3, the IMEP plot labeled “Low-RON Fuel” depicts IMEP for the engine with increasing spark advance. IMEP of the engine operating with low-RON fuel follows that of the engine operating with high-RON fuel, until spark is advanced to a point where the low-RON fuel detonates and undergoes compression or auto-ignition. As depicted, IMEP of the engine operating with low-RON fuel decreases rapidly in comparison to IMEP of the engine operating with high-RON fuel. The ignition timing of the engine operating with low-RON fuel is retarded to a point before maximum IMEP to prevent engine knock. Thus, the engine operating with low-RON fuel will not be able to output the maximum IMEP that the engine design is capable of producing.

Engines 110 having forced induction systems 130 may be more prone to compression ignition than engines that are naturally aspirated. In general, the increased effective compression ratio of the engines 110 having forced induction systems 130 brings the fuel closer to point of auto-ignition than engines that are naturally aspirated.

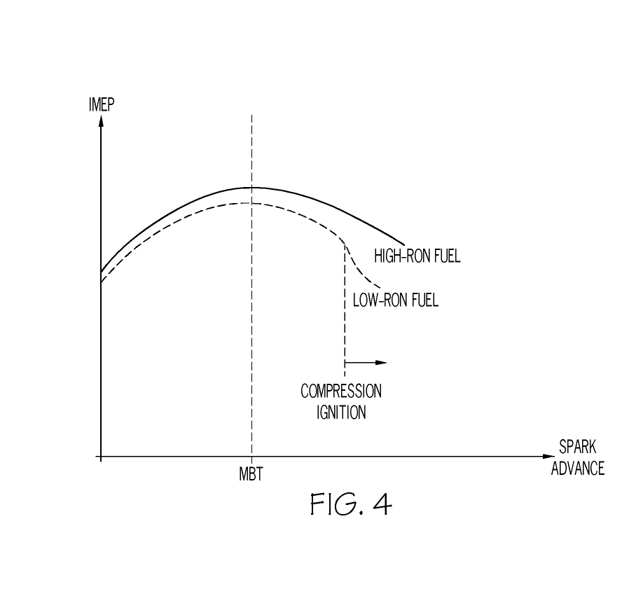

Referring now to FIG. 4, a hypothetical plot of the IMEP of an engine operating at a partial power condition is depicted. In contrast to the plot of IMEP of FIG. 3, when the engine is operating at a partial power condition, detonation of the low-RON fuel occurs at a spark timing that is advanced from the MBT timing. As such, the engine operating with the low-RON fuel produces the same IMEP as the engine operating with the high-RON fuel at these engine operating conditions. Thus, demand for the high-RON fuel may be dependent upon engine operating conditions, where high-RON fuel is needed at portions of the operating envelope of the engine.

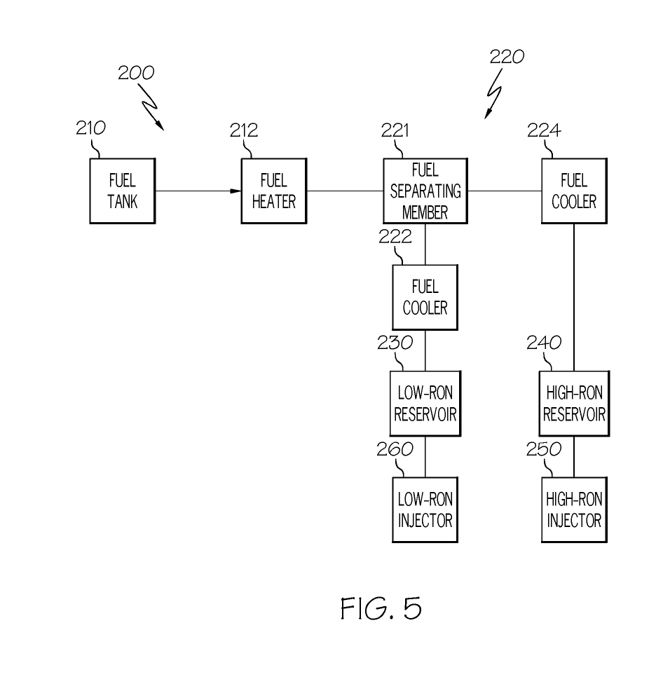

Referring now to FIG. 5, one embodiment of a fuel delivery system 200 including an on-board separator 220 is depicted. The fuel delivery system 200 includes a fuel tank 210, which stores fuel at an intermediate-RON and an on-board separator 220. Fuel from the fuel tank 210 is directed through a fuel heater 212 to the fluid separating member 221. In some embodiments, the fuel heater 212 may use the exhaust gases captured from the engine 110 to increase the temperature of the fuel. As described in further detail below, the fluid separating member 221 of the on-board separator 220 separates fuel into a permeate portion and a retentate portion. In some embodiments, the permeate portion of the fuel forms a high-RON component that has a RON greater than the intermediate-RON of the fuel in the fuel tank 210. The retentate portion of the fuel forms a low-RON component that has a RON less than the intermediate-RON of the fuel in the fuel tank 210. The high-RON component travels through a high-RON fuel cooler 224 that reduces the temperature of the high-RON component of the fuel. The high-RON component is directed into a high-RON reservoir 240, where it is stored until delivered to the engine by high-RON fuel injectors 250. Similarly, the low-RON component travels through a low-RON fuel cooler 222 that reduces the temperature of the low-RON component of the fuel. The low-RON component is directed into a low-RON reservoir 230, where it is stored until delivered to the engine by low-RON fuel injectors 260.

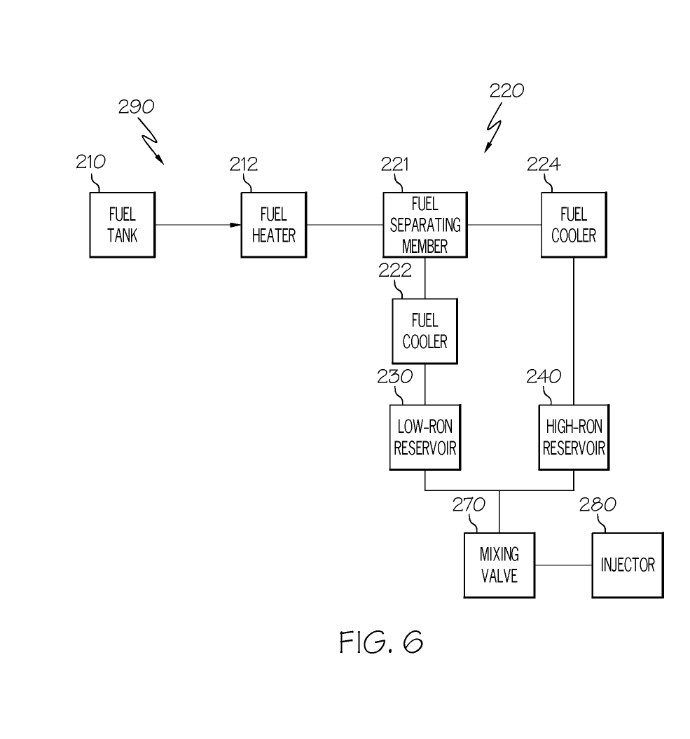

Referring now to FIG. 6, another embodiment of a fuel delivery system 290 is depicted. The fuel delivery system 290 includes a fuel tank 210, which stores fuel at an intermediate-RON and an on-board separator 220. Fuel from the fuel tank 210 is directed through a fuel heater 212 to the fluid separating member 221. The fluid separating member 221 of the on-board separator 220 separates fuel into a permeate portion and a retentate portion. In some embodiments, the permeate portion of the fuel forms a high-RON component that has a RON greater than the intermediate-RON of the fuel in the fuel tank 210. The retentate portion of the fuel forms a low-RON component that has a RON less than the intermediate-RON of the fuel in the fuel tank 210. The high-RON component travels through a high-RON fuel cooler 224 that reduces the temperature of the high-RON component of the fuel. The high-RON component is directed into a high-RON reservoir 240. Similarly, the low-RON component travels through a low-RON fuel cooler 222 that reduces the temperature of the low-RON component of the fuel. The low-RON component is directed into a low-RON reservoir 230. The high-RON component of the fuel and the low-RON component of the fuel are directed into a mixing valve 270. The mixing valve mixes the high-RON component of the fuel and the low-RON component of the fuel to a demanded proportion. The mixed low-RON and high-RON components are introduced to an injector 280, where it is delivered to the engine. In some embodiments, the mixing valve 270 and the injector 280 may be integrated into a single component or otherwise connected to minimize the volume of fuel between the mixing valve 270 and the injector 280, such that quick variations in the ratio of high-RON component and low-RON component of the fuel are delivered to the engine on demand.

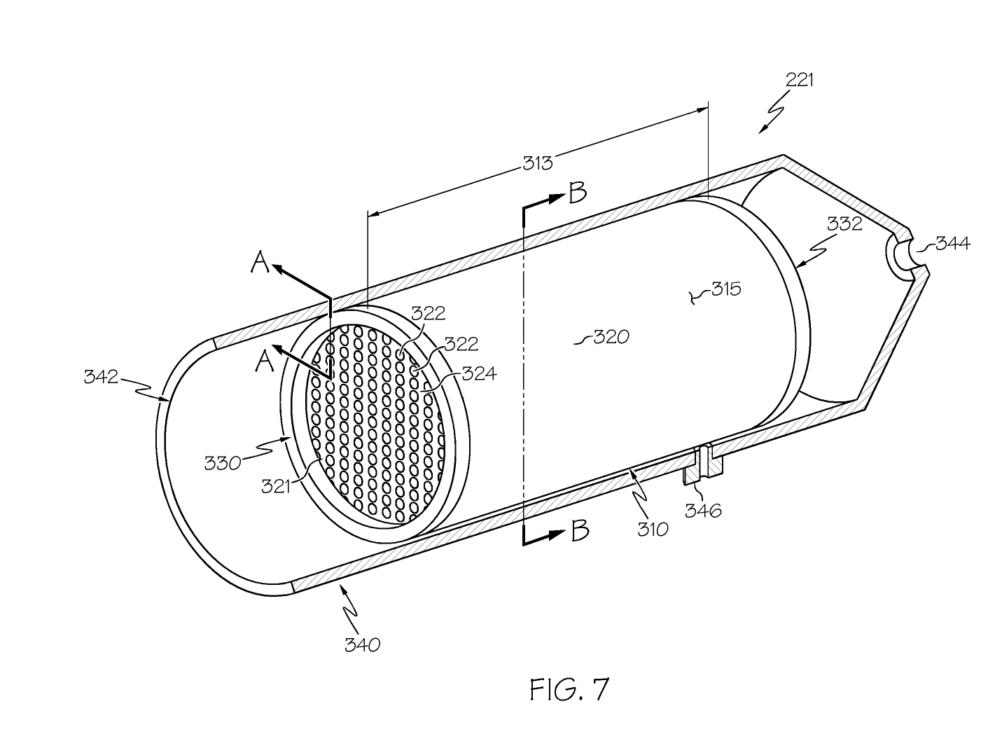

Referring now to FIG. 7, in one embodiment, the on-board separator 220 may include a fluid separating member 221 including a pervaporation member 310 having a ceramic monolith 320 that is a honeycomb-like structure that includes a plurality of parallel flow channels 322 separated by porous channel walls 324. A plurality of the porous channel walls 324 are coated with a functional membrane along an axial length 323 of the ceramic monolith 320. The ceramic monolith 320 has a skin 325, which is the outer-most surface of the ceramic monolith 320. As discussed hereinabove, the functional membrane separates fluid flowing through the ceramic monolith 320 into a retentate portion and a permeate portion by a pervaporation process. Examples of such pervaporation members are described in U.S. Pat. Pub. No. 2008/0035557 and U.S. Pat. No. 8,119,006 B2.

The term “pervaporation” refers to the ability of the targeted fluid to flow through the functional membrane on the porous channel walls 324. This phenomenon is a solution diffusion process, which is characterized by a sorption of the feed components into the membrane (characterized by Sᵢ, for solubility of a given component), diffusion through the membrane (characterized by Dᵢ, for diffusivity of a given component), and desorption of the component from the backside of the membrane into the body of the monolith. The S and D are different for each species in the feed to the assembly. This provides the permeability or permeation rate, Pᵢ, of a given material as Dᵢ×Sᵢ. Furthermore, selectivity, α_{i/j} of a species in ratio to another is given by Pᵢ/Pⱼ. Thus, the functional membrane allows for separation of the fluid stream (in these embodiments, fuel having an intermediate-RON) into a high-RON component and a low-RON component.

Preheated fuel, in particular a vapor-liquid mixture as described in U.S. Pat. No. 7,803,275, having an intermediate-RON is introduced to the ceramic monolith 320 through the separating member inlet 342. The fuel is passed into the flow channels 322 of the ceramic monolith 320. The fuel enters at the inlet side 330 and flows towards the outlet side 332. As the fuel flows along the flow channels 322 of the ceramic monolith 320, the high-RON component of the fuel permeates through the functional membrane coated on the porous channel walls 324. The high-RON component permeates outwards of the ceramic monolith 320 to a position outside of the skin 325, where it is collected in the housing 340. The high-RON component of the fuel exits the housing 340 at a permeate outlet 346.

The low-RON component of the fuel flows along the flow channels 322 of the ceramic monolith 320. The functional membrane coating the porous channel walls 324 limits the low-RON component from permeating through the porous channel walls 324. The low-RON component of the fuel flows along the axial length 323 of the ceramic monolith 320 and exits the housing 340 at a retentate outlet 344.

In the embodiments described herein, the ceramic monolith 320 may be formed with a channel density of up to about 500 channels per square inch (cpsi). For example, in some embodiments, the ceramic monolith 320 may have a channel density in a range from about 70 cpsi to about 400 cpsi. In some other embodiments, the ceramic monolith 320 may have a channel density in a range from about 200 cpsi to about 250 cpsi or even from about 70 cpsi to about 150 cpsi.

In the embodiments described herein, the porous channel walls 324 of the ceramic monolith 320 may have a thickness of greater than about 10 mils (254 microns). For example, in some embodiments, the thickness of the porous channel walls 324 may be in a range from about 10 mils up to about 30 mils (762 microns). In some other embodiments, the thickness of the porous channel walls 324 may be in a range from about 15 mils (381 microns) to about 26 mils (660 microns).

In the embodiments of the fluid separating member 221 described herein the porous channel walls 324 of the ceramic monolith 320 may have a bare open porosity % P (i.e., the porosity before any coating is applied to the ceramic monolith 320)≧35% prior to the application of any coating to the ceramic monolith 320. In some embodiments the bare open porosity of the porous channel walls 324 may be such that 20%≦% P≦60%. In other embodiments, the bare open porosity of the porous channel walls 324 may be such that 25%≦% P≦40%.

In general, ceramic monoliths 320 produced with a mean pore size greater than about 1 micron make it difficult to produce a viable membrane coating on the substrate. Accordingly, it is generally desirable to maintain the mean pore size of the porous channel walls 324 between about 0.01 microns and about 0.80 microns.

In the embodiments described herein the honeycomb body of the ceramic monolith 320 is formed from a ceramic material such as, for example, cordierite, mullite, silicon carbide, aluminum oxide, aluminum titanate or any other porous material suitable for use in elevated temperature particulate filtration applications.

The ceramic monolith 320 includes an array of flow channels that are separated by porous channel walls 324. The porous channel walls 324 extend along an axial length 323 of the ceramic monolith 320. The porous channel walls 324 allow a fluid comprising liquid and/or vapor to permeate through the porous channel walls 324 between adjacent flow channels 322. A plurality of the porous channel walls 324 are coated with a functional membrane. The functional membrane is permeable to some portions of the fluid stream and impermeable to others. By passing a fluid through the fluid separating member 221, the functional membrane separates the fluid into a retentate portion that flows through the plurality of flow channels 322, and a permeate portion that passes through the coated porous channel walls 324.

In some embodiments, the porous channel walls 324 are coated with an inorganic coating layer that is an applied intermediate layer that improves bonding performance of the functional membrane to the porous channel walls 324.

Examples of the functional membrane include Diepoxyoctane-Poly(propyleneglycol)bis(2-aminopropyleter)(MW400) (DENO-D400), an organic polymeric material. In one example, when solidified on a porous medium, DENO-D400 allows for a fluid stream, such fuel having high-RON (for example, the portion of the fuel having a RON greater than about 100) to pass through the solidified polymer and the porous medium, while limiting fuel having a low-RON from passing through the solidified polymer and the porous medium. Thus, the functional membrane separates a stream of fuel into a retentate portion having a low-RON and a permeate portion having a high-RON. While one example of a functional membrane is DENO-D400, it should be understood that other functional membranes could be used such as polyester-polyimide and polyether-epoxyamine. Examples of the functional membrane include those disclosed in U.S. Pat. Nos. 7,708,151 and 8,119,006 and U.S. Pat. Pub. No. 2008/0035557.

Embodiments of the on-board separator 220 separate the fuel stream having an intermediate-RON into a high-RON component and a low-RON component. Some embodiments of the on-board separator 220 may vary the volume and octane rating of the high-RON component that is permeated from the intermediate-RON fuel, for example, by modifying the flow rate and temperature of the intermediate-RON fuel directed into the on-board separator 220. For example, the on-board separator 220 may be configured to separate the fuel stream to provide a high-RON component having a relatively high-RON at a relatively low volume. The same on-board separator 220 may be configured to separate the fuel stream to provide a high-RON component having a relatively lower RON at a relatively higher volume. The on-board separator 220 may therefore provide the high-RON component of the fuel at the required volume and having the required octane rating for a given engine operating condition.

Referring again to FIG. 7, the permeability of the functional membrane coated onto the porous channel walls 324 may vary based on the temperature of the fluid introduced to the flow channels 322. In general, as the temperature of the fluid increases, the permeation rate of the functional membrane increases. However, as the permeation rate of the functional membrane increases, the average RON of the permeate portion of a fluid stream will decrease. An optimal operational setpoint is achieved that balances the average RON of the permeate portion of the fluid versus the permeation rate. A fluid stream introduced to the fluid separating member 221 from about 90 to about 180 degrees C. at a pressure from about 200 to about 1000 kPa provides a permeate portion of the fuel with a RON of greater than about 99.

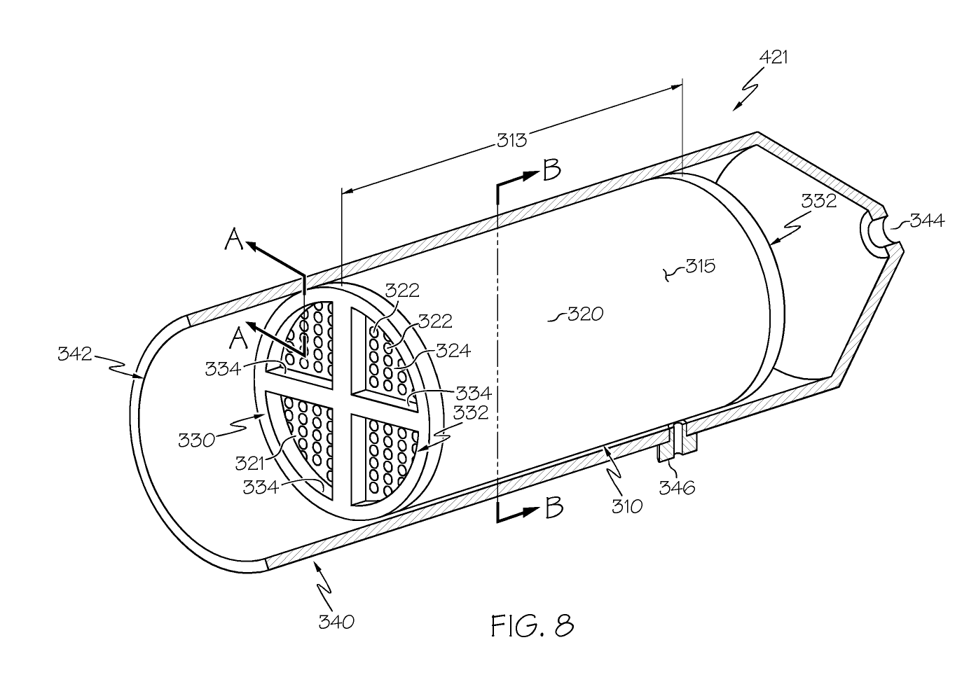

Referring now to FIG. 8, another embodiment of the fluid separating member 421 of the on-board separator 220 is depicted. In this embodiment, the fluid separating member 421 includes a pervaporation member 310 having a ceramic monolith 320 that is a honeycomb-like structure that includes a plurality of parallel flow channels 322 separated by porous channel walls 324. A plurality of the porous channel walls 324 are coated with a functional membrane along an axial length 313 of the ceramic monolith 320. The ceramic monolith 320 has a skin 325, which is the outer-most surface of the ceramic monolith 320. As discussed hereinabove, the functional membrane separates fluid flowing through the ceramic monolith 320 into a retentate portion and a permeate portion by a pervaporation process. The fluid separating member 421 includes a segmented end cap 332 having a plurality of openings 334. The segmented end cap 332 separates the ceramic monolith 320 into a plurality of discrete through segments 321 through which fuel can selectively be passed through or diverted away from. Examples of such pervaporation members are described in U.S. Provisional Patent Application Ser. No. 61/563860 (Attorney Docket No. SP11-254P) titled “Partitioned Ceramic Monoliths for Separating Fluids.”

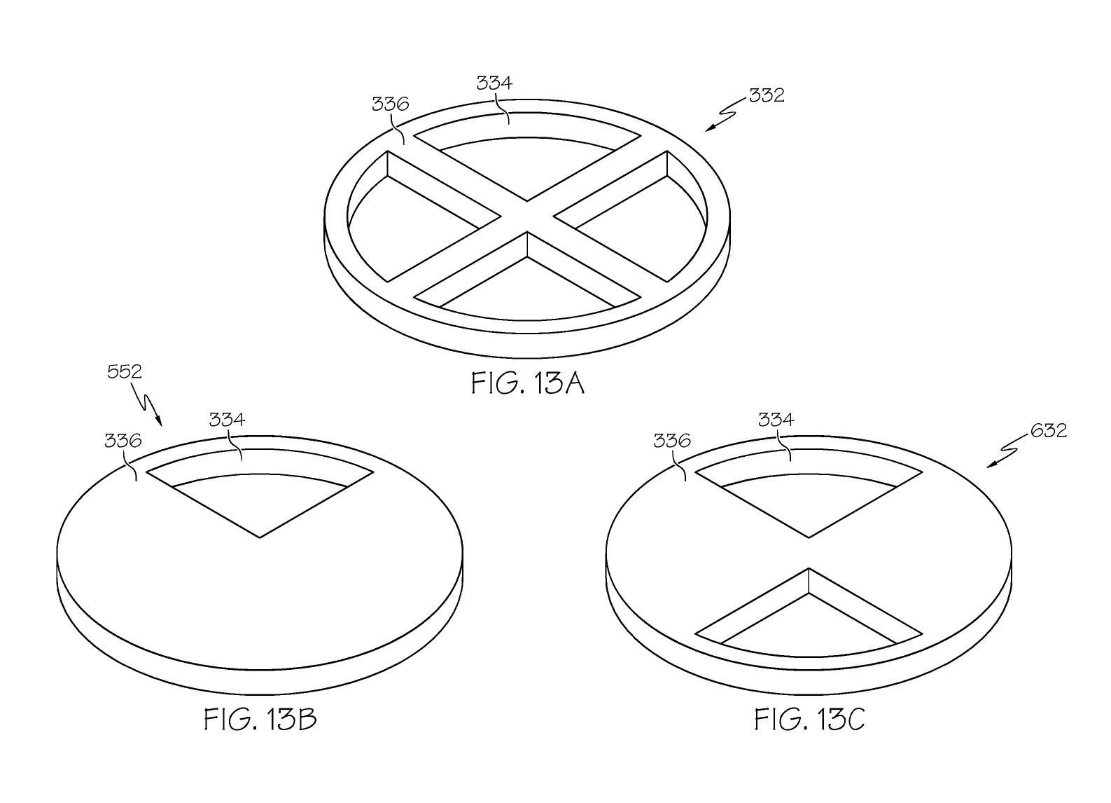

Referring to FIGS. 13A-C, multiple embodiments of segmented end caps 332, 532, 632 are depicted. In these embodiments, the segmented end caps 332, 532, 632 have varying number of openings 334, which are separated from one another by wall portions 336. The wall portions 336 correspond to regions of the porous channel walls 324 and the flow channels 322 of the ceramic monolith 330 that are masked from fluid entering the on-board separator 220, as depicted in FIG. 8. In some embodiments, the discrete through segments 321 positioned proximate to the openings 334 of the segmented end caps 332, 532, 632 may be separated from one another by uncoated porous channel walls 324 (not shown), which are positioned behind the wall portions 336 of the segmented end caps 332, 532, 632. Accordingly, it should be understood that the openings 334 of the segmented end caps 332, 532, 632 may be used to isolate discrete through segments of a monolith assembly to which the segmented end cap 332, 532, 632 is attached, thereby limiting the entry of fluid into the ceramic monolith 330 to only the discrete through segment exposed in the opening 334 and masking the other porous channel walls 324 and flow channels 322. FIG. 13A depicts a segmented end cap 332 having four openings 334, which correspond to four through segments in the ceramic monolith 330 (not shown), which are isolated from one another by porous channel walls 324 and flow channels 322 positioned behind the wall portions 336 of the segmented end cap 332. FIG. 13B depicts a segmented end cap 532 which comprises one opening 334 which isolates corresponding through segments of ceramic monolith 330 (not shown) to which the segmented end cap 532 is attached. FIG. 13C depicts a segmented end cap 632 which comprises two openings 334 which isolate corresponding through segments of the ceramic monolith 330 (not shown) to which the segmented end cap 632 is attached. In these embodiments, the segmented end caps 332, 532, 632 only permit the entry of fluid into the discrete through segments of the ceramic monolith 330 which are exposed in the openings 334, and prevents fluid entry into the discrete through segments of the ceramic monolith 330 masked by the wall portions 366 of the segmented end caps 332, 532, 632.

While FIGS. 13A, 13B and 13C depict segmented end caps with 4, 1, and 2 openings, respectively, it should be understood that the segmented end caps may be constructed with any number of openings to facilitate exposing and/or masking a desired number of through segments of a ceramic monolith. Using the segmented end caps to control the flow of fluid into a specific number of discrete through segments may be used to control the yield of the pervaporation member, the permeate/retentate separation rate of the pervaporation member, and the concentration of volatiles in the permeate and retentate portions of the separated fluid. For example, decreasing the number of exposed through segments from two (i.e., when using the segmented end cap of FIG. 13B) to one (i.e., when using the segmented end cap of FIG. 13C) decreases the permeate yield of the pervaporation member by half and also reduces the separation rate. However, the permeate may have lower concentrations of volatiles than permeate derived from a pervaporation member utilizing two through segments. Therefore, the number of exposed through segments of the ceramic monolith through which fluid is passed may be varied to provide permeate having the desired volume and concentration of volatiles for a particular end-user application.

In some embodiments, fuel introduced to the pervaporation member may be selectively directed to a quantity of discrete through segments less than all of the quantity of discrete through segments positioned behind the openings 334 of the segmented end caps. Referring to FIG. 13A, in one embodiment, the segmented end cap 332 includes four openings 334 and the corresponding ceramic monolith includes four discrete through segments 321 (as depicted in FIG. 8), fuel may be directed to only one of the openings 334 and corresponding discrete through segment and diverted away from the remaining openings 334 and corresponding discrete through segments to control the volume and the RON of the permeate that is separated from the retentate as the fuel passes through the pervaporation member. As such, the quantity of discrete through segments to which fuel is introduced may be less than the total number of discrete through segments of the ceramic monolith.

It should be understood that alternative apparatuses and methods for selectively distributing fuel to the discrete through segments of the ceramic monolith may be incorporated without departing from the scope of the present disclosure.

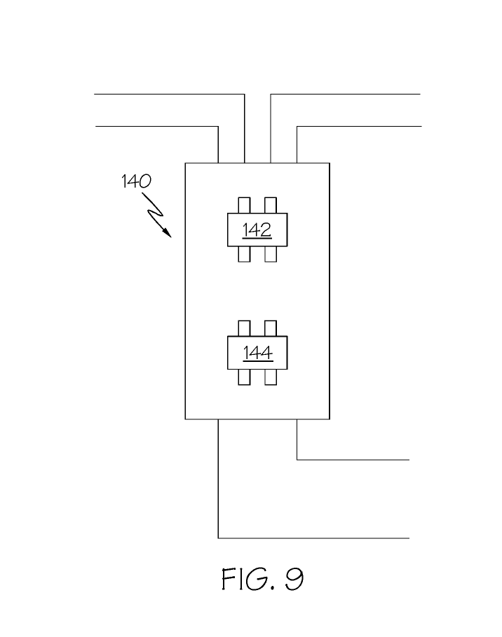

Referring now to FIG. 9, the ECU 140 includes a memory 142 and a processor 144 electrically coupled to one another. A series of operating instructions are stored in the memory 142 of the ECU 140 for managing operation of the engine. In some embodiments, the operating instructions stored in the memory 142 of the ECU 140 include “fuel maps” that control the amount of fuel to be delivered to each of the engine cylinders, which is based on a plurality of engine operating conditions provided to the ECU 140 by a plurality of engine performance sensors. The operating instructions stored in the memory 142 of the ECU 140 also include “spark maps” that control the timing of the spark ignition source in each of the engine cylinders.

In one embodiment, the ECU 140 is electrically coupled to the high-RON fuel injectors 250 and the low-RON fuel injectors 260 (shown in FIG. 5). In this embodiment, the ECU 140 selectively introduces high-RON fuel and low-RON fuel to the engine cylinders based on the operating parameters of the engine. For example, when the engine is operating at a full power condition or at a near-full power condition, the ECU 140 may demand a greater portion of the total fuel delivery to each of the engine cylinders is delivered from the high-RON fuel injectors 250 than the low-RON fuel injectors 260. The ECU 140 may modify the demand for the portion of fuel delivered from the high-RON fuel injectors 250 from the baseline portion specified by the fuel map based on a signal provided by the engine knock sensor 150, as described hereinabove.

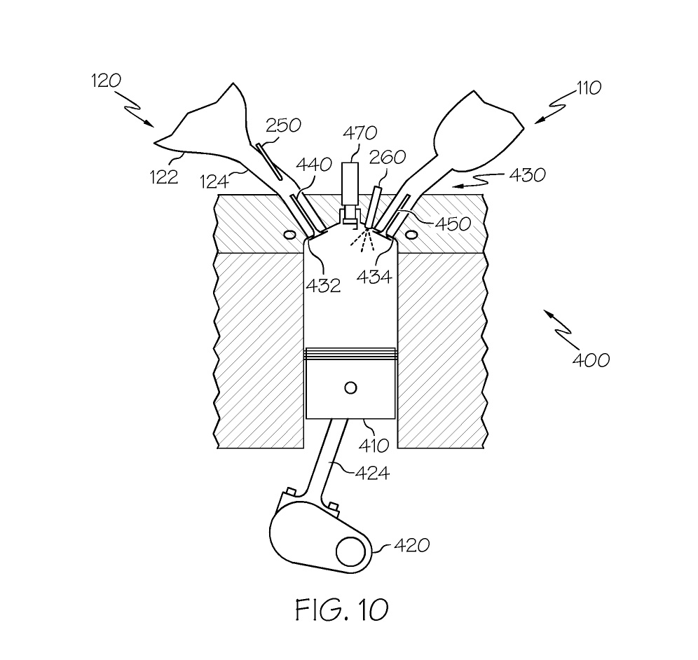

Referring now to FIG. 10, an engine cylinder 400 is schematically depicted. An engine 110 may have a plurality of engine cylinders 400 arranged in a variety of configurations, as is conventionally known. The engine cylinder 400 includes a piston 410 that reciprocates within the engine cylinder 400. The piston 410 is coupled to the crankshaft 420 by a connecting rod 424. Air 90 is introduced to the engine cylinder 400 from the plenum 122 of the intake manifold 120. As air flows into the engine cylinder 400, the high-RON fuel injector may inject high-RON fuel into the intake runner 124. The air 90 enters the engine cylinder 400 passing around an opened intake valve 440 positioned in an inlet port 432 in an engine head 430. As pressure in the engine cylinder 400 increases due to reciprocation of the piston 410 and a decrease in volume in the engine cylinder 400, the intake valve 440 closes such that the volume of air 90 within the engine cylinder 400 is held constant. As the piston 410 travels towards the engine head 430, the pressure of the air in the engine cylinder 400 increases. During the compression stroke, low-RON component fuel may be introduced to the engine cylinder 400 through the low-RON fuel injector 260. As depicted in FIG. 10, the low-RON fuel injector 260 injects fuel directly into the engine cylinder 400.

As the piston 410 approaches TDC, the ECU 140 signals the spark plug 470 to create a spark. The spark plug 470 locally heats the air-fuel mixture positioned proximate to the spark plug 470, which causes a flame front to develop within the engine cylinder 400, combusting the fuel in the engine cylinder 400. The combustion of the fuel in the air-fuel mixture increases the temperature and pressure of the combusted air-fuel mixture. The increase in pressure is extracted from the combusted air-fuel mixture as the piston 410 reciprocates downwards, away from the engine head 430 in an expansion stroke. After completion of the expansion stroke, the combusted air-fuel mixture is directed out of the engine cylinder 400 through an open exhaust valve 450 positioned within an exhaust port 434 the engine head 430.

As depicted in FIG. 10, fuel injected into the intake runner 124 of the intake manifold 120 generally forms a homogenous air-fuel mixture, or generally evenly mixed, in the engine cylinder 400. This homogenous air-fuel mixture is generally “stoichiometric,” where the quantity of air and fuel are in balance such that there is complete combustion of the fuel and no excess oxygen in the combusted air-fuel mixture. Stoichiometric air-fuel mixtures encourage complete combustion of fuel in the air-fuel mixture. Stoichiometric air-fuel mixtures provide the maximum IMEP for a given engine operating point. Stoichiometric air-fuel mixtures also provide the highest inner-cylinder temperatures for a given engine operating point.

Fuel injected into the engine cylinder 400 can form either a homogenous air-fuel mixture in the engine cylinder 400, or can form a stratified air-fuel mixture in the engine cylinder 400. If fuel is injected during the compression stroke of the engine, the air-fuel mixture proximate to the low-RON injector 260 can approach stoichiometric, to encourage combustion, while the air-fuel mixture located distally from the low-RON injector 260 remains lean. The stoichiometric air-fuel ratio for a gasoline powered engine is 14.7:1, by weight. The average air-fuel ratio for a stratified air-fuel mixture can be greater than 16:1, by weight. In some embodiments, the average air-fuel ratio for a stratified air-fuel mixture can be greater than 20:1, by weight. In further embodiments, the average air-fuel ratio for a stratified air-fuel mixture can be greater than 40:1, by weight. In still further embodiments, the average air-fuel ratio for a stratified air-fuel mixture can be greater than 65:1, by weight. Lean-burn stratified air-fuel mixtures may be used at low power engine conditions where maximum engine power is not required. Lean burn stratified air-fuel mixtures provide lower inner-cylinder temperatures for a given engine operating point compared to stoichiometric homogenous air-fuel mixtures. Lean burn stratified air-fuel mixtures generally provide lower fuel consumption per stroke because of decreased fuel usage and increased y, which increases the thermal efficiency of the engine.

In general, engines are more prone to knock during high power engine operating conditions than during low power engine operating conditions. Because fuel having a high-RON component is delivered to the engine cylinder during the high power engine operating conditions, the engine can operate at stoichiometric air-fuel mixtures, such that combustion efficiency and thermal efficiency of the engine are maximized. As such, specific fuel consumption of engines operating with the fuel delivery system according to the present disclosure are lower than specific fuel consumption of engines operating with lower RON fuel and/or engines operating with “anti-knock” agents that are introduced to prevent engine knock.

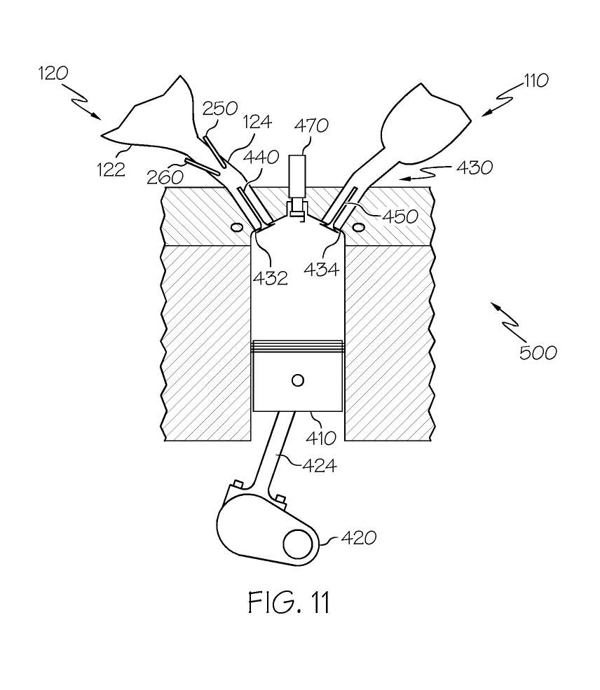

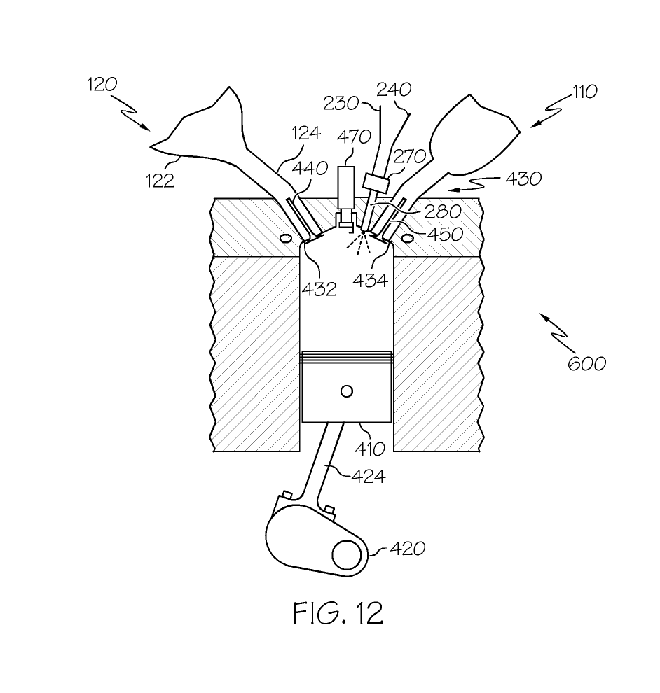

Referring now to FIGS. 11 and 12, other embodiments of engine cylinders 500, 600 are schematically depicted. In the embodiment depicted in FIG. 11, the high-RON injector 250 and the low-RON injector 260 are both positioned in the intake runner 124 of the intake manifold 120. The high-RON injector 250 and the low-RON injector 260 introduce fuel to the intake runner 124 and the fuel enters the engine cylinder 500 passing around the opened intake valve 440 positioned in the inlet port 432 of the engine head 430.

In the embodiment depicted in FIG. 12, the high-RON reservoir 240 and the low-RON reservoir 230 are coupled to a mixing valve 270. The mixing valve 270 is coupled to an injector 280 positioned in the engine head 430 to inject fuel directly into the engine cylinder 600. By positioning the mixing valve 270 proximate to the injector 280, the proportion of high-RON component and low-RON component of the fuel injected into the engine cylinder 600 may be adjusted quickly to respond to power demands of the engine 110 and/or to mitigate knock. In some embodiments, the proportion of high-RON and low-RON component of the fuel may be adjusted on a per cycle basis (i.e., adjusted from injection pulse to injection pulse of the injector 280).

Referring again to FIG. 1, some embodiments of the powertrain system 100 may include an exhaust gas recirculation (EGR) system 160. The EGR system 160 is in fluid communication with both the outlet manifold of the engine 110 and the intake manifold 120. The EGR system 160 directs combusted air-fuel mixture from the engine exhaust back into the intake manifold 120. The EGR system 160 may include an intercooler (not shown) that decreases the temperature of, and therefore increases the density of, the combusted air-fuel mixture. The combusted air-fuel mixture that passes through the EGR system 160 has oxygen content that approaches zero. The combusted air-fuel mixture is mixed with uncombusted air in the intake manifold 120. The mixture of combusted and uncombusted air is directed into the engine cylinder, where it becomes the working fluid of the engine cycle. Because the combusted air-fuel mixture has a decreased quantity of oxygen, the combusted air-fuel mixture reduces the amount of oxygen available for combustion with the fuel. Thus, less fuel is required to be injected into the engine cylinders to maintain a stoichiometric air-fuel ratio when combusted air-fuel mixture from the EGR system 160 is introduced to the engine cylinder. The reduction of oxygen and fuel in the engine cylinder may reduce inter-cylinder temperatures, which may reduce vehicle emissions and decrease rejected heat from the engine.

Still referring to FIG. 1, the engine knock sensor 150 is coupled to the engine to sense engine knock. In some embodiments, the engine knock sensor 150 is a piezo-electric sensor that detects the sound of engine knock. The engine knock sensor 150 is electrically coupled to the ECU 140. When the engine knock sensor 150 senses engine knock and transmits a signal to the ECU 140 indicative of this, the ECU 140 adjusts engine operating parameters to prevent the engine knocking. For example, the ECU 140 may signal the high-RON fuel injector 250 to increase its flow rate and the low-RON fuel injector 260 to decrease its flow rate. As such, the relative proportion of fuel flowing from the high-RON fuel injector 250 will increase as compared to the low-RON fuel injector 260. Thus, the average RON of the fuel introduced to the engine cylinder will increase.

Alternatively, or in addition, the ECU 140 may retard timing by firing the spark plug later in the engine cycle. As discussed hereinabove, retarding the timing reduces engine power output and reduces the likelihood of damage to the engine caused by knock.

Alternatively, or in addition, the ECU 140 may signal the wastegate of the forced induction system to open, thereby allowing combusted exhaust gas to bypass the turbine of the turbocharger. The turbine and the compressor of the turbocharger will decrease in speed, thereby reducing pressure in the intake manifold. Reducing the pressure in the intake manifold reduces engine power output and reduces the likelihood of damage to the engine caused by knock.

Alternatively, or in addition, the ECU 140 may command the variable-geometry turbocharger to modify the position of the nozzles, thereby reducing pressure of the combusted exhaust gases on the turbine of the turbocharger. The turbine and the compressor of the turbocharger will decrease in speed, thereby reducing pressure in the intake manifold. Reducing the pressure in the intake manifold reduces engine power output and reduces the likelihood of damage to the engine caused by knock.

Further, the ECU 140 may alter the temperature or pressure of the fuel that is introduced to the on-board separator 220 such that the quantity and octane rating of the high-RON component of the fuel is adjusted. Modifying the temperature and pressure of the fuel that enters the on-board separator 220 may provide the engine with sufficient fuel at a high octane rating to continue to operate.

### FUEL SEPARATION EXAMPLES

A regular unleaded fuel blend having a base octane rating of 92.5 RON and 9.7 wt % ethanol content was separated by use of a pervaporation membrane (as described in U.S. Pat. No. 8,119,006 and U.S. Provisional Patent Application Ser. No. 61/476,988) to obtain a high-RON component and a low-RON component from the fuel. A 4-segment partitioned ceramic monolith as shown in FIG. 8 and described in U.S. Provisional Patent Application Ser. No. 61/563,860 (Attorney Docket No. SP11-254P) titled “Partitioned Ceramic Monoliths for Separating Fluids” was used.

Typical operating conditions of the pervaporation member included a feed rate of 4-6 g/s-m², pressure of 500 kPa (absolute), fuel inlet temperature of 140-160° C., and a permeate side pressure of 25 kPa (absolute). Table 1 shows 40% (w/w) yield (permeate) of the high-RON component having 97 RON was obtained at typical operating conditions, by using multiple segments. Lowering yield to 20% (permeate) by using only one segment resulted in a high-RON component having 101 RON. The corresponding lower RON component (retentate) produced from the fuel are also shown.

TABLE 1
Separated Fuel Components from Regular Unleaded Gasoline at 92.5 RON
Having 9.7 wt % Ethanol

| | Higher Permeate | Lower Permeate |
|---|---|---|
| | Yield Volume | Yield Volume |
| High Octane Component | | |
| Fraction HiRON | 41.2% | 20.8% |
| Octane HiRON, RON | 97 | 101.3 |
| Ethanol, wt % | 16.5% | 21.3% |
| Low Octane Component | | |
| Fraction LoRON | 58.8% | 79.2% |
| Octane, LoRON, RON | 90.6 | 91.0 |
| Ethanol, wt % | 5.1% | 6.6% |

It should be understood that powertrain systems according to the present disclosure include forced induction systems to increase power output of the engine. The powertrain systems further include fuel delivery systems having on-board separators that separate fuel into a high-RON component and a low-RON component. The high-RON component is delivered to the engine at high power operating conditions where the engine is prone to knock. The low-RON component is delivered to the engine at low power operating conditions. The engine utilizes the high-RON component of the fuel at operating conditions where the increase in pre-ignition resistance allows for additional spark advance to develop more power.

In a first aspect, the disclosure provides a powertrain system 100 for a vehicle comprising: an engine 110 comprising a plurality of engine cylinders 400 each having an inlet port 432 and an exhaust port 434; an intake manifold 120 in fluid communication with the inlet ports of each of the engine cylinders 400 of the engine 110; a forced induction system 130 coupled to the engine 110 increasing an intake pressure of air 90 in the intake manifold 120 above ambient pressure; and a fuel delivery system 200 supplying fuel to each of the engine cylinders 400 of the engine 110, wherein the fuel delivery system 200 comprises at least one fuel injector 280 per engine cylinder 400, a fuel tank 210 storing fuel having an intermediate-RON, and an on-board separator 220 separating the fuel into a high-RON component and a low-RON component for targeted delivery to each of the engine cylinders 400 of the engine 110 based on an engine 110 operating parameter.

In a second aspect, the disclosure provides a method of operating a powertrain system 100 comprising an engine 110 having a plurality of cylinders, an intake manifold 120 in fluid communication with the engine cylinders 400, a forced induction system 130 coupled to the intake manifold 120 to increase pressure in the intake manifold 120 above ambient, and a fuel delivery system 200 supplying fuel to each of the engine cylinders 400, the fuel delivery system 200 comprising at least one fuel injector 280 per engine cylinder 400, a fuel tank 210 storing fuel at an intermediate-RON, and an on-board separator 220, the method comprising: introducing the fuel to the on-board separator 220; pre-heating the fuel; passing the fuel through a pervaporation member 310 as to separate the fuel into a low-RON component and a high-RON component; cooling the low-RON component and the high-RON component; storing the high-RON component in a high-RON reservoir 240; delivering air 90 and fuel to the each of the engine cylinders 400; determining if compression ignition is occurring in any of the engine cylinders 400, and if compression ignition is detected, increasing a proportion of fuel delivered to each of the engine cylinders 400 from the high-RON reservoir 240.

In a third aspect, the disclosure provides the powertrain system 100 of any of the first or second aspects, wherein the on-board separator 220 comprises a pervaporation member 310 comprising a ceramic monolith 320 having a plurality of parallel flow channels 322 separated by porous channel walls 324 and at least a portion of the porous channel walls 324 are coated with a functional membrane separating a fuel into the high-RON component and the low-RON component by a pervaporation process, wherein the high-RON component of the fuel permeates through the porous channel walls 324 and the low-RON component is retained by the polymer coated porous channel walls 324 and flows along the flow channels 322.

In a fourth aspect, the disclosure provides the powertrain system 100 of any of the second or third aspects, wherein the pervaporation member 310 further comprises a plurality of discrete through segments separated from one another by uncoated porous channel walls 324.

In a fifth aspect, the disclosure provides the powertrain system 100 of any of the first through fourth aspects, wherein the forced induction system 130 comprises a turbocharger comprising a turbine coupled to a compressor, wherein the turbine is in fluid-communication with the exhaust ports of the plurality of cylinders, and the compressor is in fluid-communication with the intake manifold 120.

In a sixth aspect, the disclosure provides the powertrain system 100 of any of the first through fifth aspects wherein the engine 110 further comprises a crankshaft 420 and the forced induction system 130 comprises a supercharger comprising a compressor in fluid communication with the intake manifold 120 and coupled to the crankshaft 420.

In a seventh aspect, the disclosure provides the powertrain system 100 of any of the first through sixth aspects, wherein the on-board separator 220 comprises a pervaporation member 310 comprising a polymer coated ceramic monolith 320 having a plurality of flow channels 322 defined by polymer coated porous walls 324, wherein the high-RON component of the fuel permeates through the polymer coated porous channel walls 324 and the low-RON component is retained by the polymer coated porous channel walls 324 and flows along the flow channels 322.

In an eighth aspect, the disclosure provides the powertrain system 100 of any of the first through seventh aspects, wherein the on-board separator 220 further comprises a fuel heater 212 that increases a temperature of the fuel passing from the fuel tank 210 to the pervaporation member 310.

In a ninth aspect, the disclosure provides the powertrain system 100 of any of the first through eighth aspects, wherein the fuel delivery system 200 further comprises a high-RON reservoir 240 storing fuel having a high-RON.

In a tenth aspect, the disclosure provides the powertrain system 100 of any of the first through ninth aspects further comprising: an engine knock sensor 150 coupled to the engine 110, where the engine knock sensor 150 senses compression ignition of an air 90-fuel mixture within the engine cylinders 400; and an engine 110 control unit electrically coupled to the engine knock sensor 150 and the fuel injectors, wherein when the engine knock sensor 150 senses compression ignition of the air 90-fuel mixture within the engine cylinders 400, the engine 110 control unit increases RON of the fuel introduced to the engine cylinders 400 by the fuel injectors.

In an eleventh aspect, the disclosure provides the powertrain system 100 of any of the first through tenth aspects, wherein the plurality of fuel injectors are coupled to the intake manifold 120 such that fuel is delivered to the engine cylinders 400 through the inlet port 432.

In a twelfth aspect, the disclosure provides the powertrain system 100 of any of the first through eleventh aspects, wherein the plurality of fuel injectors are coupled to the engine 110 such that fuel is delivered through direct injection to the engine cylinders 400.

In an thirteenth aspect, the disclosure provides the powertrain system 100 of any of the first through twelfth aspects further comprising an exhaust gas recirculation system 160 that is in fluid communication with the exhaust ports of the engine cylinders 400 and the inlet ports of the engine cylinders 400.

In a fourteenth aspect, the disclosure provides the powertrain system 100 of any of the first through thirteenth aspects, wherein an air 90-fuel mixture combusted in each of the engine cylinders 400 at a low-power operating condition is at least 10% more lean than stoichiometric.

In a fifteenth aspect, the disclosure provides the powertrain system 100 of any of the first through fourteenth aspects, wherein air 90 in the plurality of cylinders of the engine 110 has an effective compression ratio greater than the geometric compression ratio of the engine 110.

In a sixteenth aspect, the disclosure provides the powertrain system 100 of any of the first through fifteenth aspects, wherein at an operating condition of the engine 110, a spark timing for spark ignition of the fuel in the fuel tank 210 is retarded from a maximum brake torque timing for the operating condition.

In a seventeenth aspect, the disclosure provides the powertrain system 100 of any of the first through sixteenth aspects, wherein at a high power operating condition of the engine 110, a spark timing when using the high-RON component is advanced compared to when using fuel at an intermediate-RON.

In an eighteenth aspect, the disclosure provides the powertrain system 100 of any of the first through seventeenth aspects, wherein the air-fuel mixture is homogenous at a high power operating condition.

In a nineteenth aspect, the disclosure provides the powertrain system 100 of any of the first through seventeenth aspects, wherein the high-RON component of the fuel separated by the pervaporation member 310 has an ethanol content at least about 50% greater than the ethanol content of the fuel.

In a twentieth aspect, the disclosure provides the powertrain system 100 of any of the first through nineteenth aspects, wherein the high-RON component of the fuel separated by the pervaporation member 310 has an ethanol content at least about 100% greater than the ethanol content of the fuel.

In a twenty-first aspect, the disclosure provides the powertrain system 100 of any of the first through twentieth aspects, wherein the low-RON component of the fuel separated by the pervaporation member 310 has an ethanol content at least 10% less than the ethanol content of the fuel.

In a twenty-second aspect, the disclosure provides the powertrain system 100 of any of the first through twenty-first aspects, wherein the high-RON component has a RON at least about 3% greater than a RON of the fuel.

In a twenty-third aspect, the disclosure provides the powertrain system 100 of any of the first through twenty-first aspects, wherein at low-load operating conditions, decreasing the proportion of fuel delivered to each of the engine cylinders 400 from the high-RON reservoir 240.

In a twenty-fourth aspect, the disclosure provides the powertrain system 100 of any of the first through twenty-third aspects, further comprising directing the fuel through a quantity of discrete through segments of the pervaporation member 310, the quantity being less than the total quantity of discrete through segments of the pervaporation member 310 to control at least one of the rate, yield or RON of permeate produced during the separation process.

In a twenty-fifth aspect, the disclosure provides the powertrain system 100 of the twenty-fourth aspect, further comprising directing the fuel into a second quantity of discrete through segments less than the first quantity of discrete through segments to decrease the yield of permeate produced during the separation process and increase the RON of the permeate produced during the separation process.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

What is claimed is:

1. A powertrain system for a vehicle comprising:
an engine comprising a plurality of engine cylinders each having an inlet port and an exhaust port;
an intake manifold in fluid communication with the inlet ports of each of the engine cylinders of the engine;
a forced induction system coupled to the engine increasing an intake pressure of air in the intake manifold above ambient pressure; and
a fuel delivery system supplying fuel to each of the engine cylinders of the engine, wherein the fuel delivery system comprises at least one fuel injector per engine cylinder, a fuel tank storing fuel having an intermediate-RON, and an on-board separator separating the fuel into a high-RON component and a low-RON component for targeted delivery to each of the engine cylinders of the engine based on an engine operating parameter.

2. The powertrain system of claim 1, wherein the on-board separator comprises a pervaporation member comprising a ceramic monolith having a plurality of parallel flow channels separated by porous channel walls and at least a portion of the porous channel walls are coated with a functional membrane separating a fuel into the high-RON component and the low-RON component by a pervaporation process, wherein the high-RON component of the fuel permeates through the porous channel walls and the low-RON component is retained by the polymer coated porous channel walls and flows along the flow channels.

3. The powertrain system of claim 2, wherein the pervaporation member further comprises a plurality of discrete through segments separated from one another by uncoated porous channel walls.

4. The powertrain system of claim 1, wherein the forced induction system comprises a turbocharger comprising a turbine coupled to a compressor, wherein the turbine is in fluid-communication with the exhaust ports of the plurality of cylinders, and the compressor is in fluid-communication with the intake manifold.

5. The powertrain system of claim 1, wherein the engine further comprises a crankshaft and the forced induction system comprises a supercharger comprising a compressor in fluid communication with the intake manifold and coupled to the crankshaft.

6. The powertrain system of claim 5, wherein the on-board separator further comprises a fuel heater that increases a temperature of the fuel passing from the fuel tank to the pervaporation member.

7. The powertrain system of claim 6, wherein the fuel delivery system further comprises a high-RON reservoir storing fuel having a high-RON.

8. The powertrain system of claim 1 further comprising:
an engine knock sensor coupled to the engine, where the engine knock sensor senses compression ignition of an air-fuel mixture within the engine cylinders; and
an engine control unit electrically coupled to the engine knock sensor and the fuel injectors, wherein when the engine knock sensor senses compression ignition of the air-fuel mixture within the engine cylinders, the engine control unit increases RON of the fuel introduced to the engine cylinders by the fuel injectors.

9. The powertrain system of claim 1, wherein the plurality of fuel injectors are coupled to the intake manifold such that fuel is delivered to the engine cylinders through the inlet port.

10. The powertrain system of claim 1, wherein the plurality of fuel injectors are coupled to the engine such that fuel is delivered through direct injection to the engine cylinders.

11. The powertrain system of claim 1 further comprising an exhaust gas recirculation system that is in fluid communication with the exhaust ports of the engine cylinders and the inlet ports of the engine cylinders.

12. The powertrain system of claim 1, wherein an air-fuel mixture combusted in each of the engine cylinders at a low-power operating condition is at least 10% more lean than stoichiometric.

13. The powertrain system of claim 1, wherein air in the plurality of cylinders of the engine has an effective compression ratio greater than the geometric compression ratio of the engine.

14. The powertrain system of claim 1, wherein at an operating condition of the engine, a spark timing for spark ignition of the fuel at intermediate RON in the fuel tank is retarded from a maximum brake torque timing for the operating condition.

15. The powertrain system of claim 1, wherein at a high power operating condition of the engine, a spark timing when using the high-RON component is advanced compared to when using fuel at an intermediate-RON.

16. The powertrain system of claim 1, wherein the air-fuel mixture is homogenous at a high power operating condition.

17. A method of operating a powertrain system comprising an engine having a plurality of cylinders, an intake manifold in fluid communication with the engine cylinders, a forced induction system coupled to the intake manifold to increase pressure in the intake manifold above ambient, and a fuel delivery system supplying fuel to each of the engine cylinders, the fuel delivery system comprising at least one fuel injector per engine cylinder, a fuel tank storing fuel at an intermediate-RON, and an on-board separator, the method comprising:
introducing the fuel to the on-board separator;
pre-heating the fuel;
passing the fuel through a pervaporation member as to separate the fuel into a low-RON component and a high-RON component;
cooling the low-RON component and the high-RON component;
storing the high-RON component in a high-RON reservoir;
delivering air and fuel to the each of the engine cylinders;
determining if compression ignition is occurring in any of the engine cylinders, and if compression ignition is detected, increasing a proportion of fuel delivered to each of the engine cylinders from the high-RON reservoir.

18. The method of claim 17, wherein the high-RON component of the fuel separated by the pervaporation member has an ethanol content at least about 50% greater than the ethanol content of the fuel.

19. The method of claim 17, wherein the high-RON component of the fuel separated by the pervaporation member has an ethanol content at least about 100% greater than the ethanol content of the fuel.

20. The method of claim 17, wherein the low-RON component of the fuel separated by the pervaporation member has an ethanol content at least 10% less than the ethanol content of the fuel.

21. The method of claim 17, wherein the high-RON component has a RON at least about 3% greater than a RON of the fuel.

22. The method of claim 17, wherein the pervaporation member comprises a polymer coated porous ceramic monolith having a plurality of flow channels defined by polymer coated channel walls, wherein the high-RON component of the fuel permeates through the porous channel walls and the low-RON component is retained by the polymer coated channel walls and flows along the flow channels.

23. The method of claim 17, wherein at low-load operating conditions, decreasing the proportion of fuel delivered to each of the engine cylinders from the high-RON reservoir.

24. The method of claim 17, wherein an air-fuel mixture combusted in each of the engine cylinders at a low-power operating condition is at least 10% more lean than stoichiometric.

25. The method of claim 17, wherein the air-fuel mixture is homogenous at a high power operating condition.

26. The method of claim 17, wherein at a high power operating condition of the engine, a spark timing when using the high-RON component is advanced compared to when using fuel at an intermediate-RON.

27. The method of claim 17, further comprising directing the fuel into a first quantity of discrete through segments of the pervaporation member, the first quantity being less than the total quantity of discrete through segments of the pervaporation member to control at least one of the rate, yield or RON of permeate produced during the separation process.

28. The method of claim 27, further comprising directing the fuel into a second quantity of discrete through segments less than the first quantity of discrete through segments to decrease the yield of permeate produced during the separation process and increase the RON of the permeate produced during the separation process.
